(19) United States
(12) Patent Application Publication
(10) Pub. No.: US 2015/0009468 A1
(43) Pub. Date: Jan. 8, 2015

(54) EYEWEAR SYSTEM WITH A TENSIONER

(71) Applicant: AKADEMA, INC., HAWTHOME, NJ (US)

(72) Inventors: Lawrence J. Gilligan, Ringwood, NJ (US); Joseph F. Gilligan, Ringwood, NJ (US)

(21) Appl. No.: 13/934,555

(22) Filed: Jul. 3, 2013

(51) Int. Cl. G02C 5/06; G02C 5/00; G02C 5/08; G02C 5/14

(52) U.S. Cl. CPC G02C 5/06; G02C 5/14; G02C 5/006; G02C 5/08
USPC 351/63; 351/126; 351/113

(57) ABSTRACT

An eyewear system and method for wearing by a user is provided. The eyewear system includes a pair of glasses and a pair of temples, wherein the temples are configured to reach only up till temple bone of its wearer. Further, the eyewear system includes a frame for supporting the pair of glasses and the pair of temples. The frame of the eyewear system further includes a tensioner at its nose bridge. The tensioner is designed to pressurize the frame of the eyewear system to attain a folded position. The pressure exerted on the frame of the eyewear results in a grip of the eyewear system on facial structure of the user who is wearing the eyewear system. In addition, the pair of temples of the eyewear system includes cushions for comforting the user from the pressure exerted by the tensioner on the frame of the eyewear system.

### BACKGROUND

1. Field of the Invention

Embodiments of the present invention generally relate to eyewear. More specifically, the present invention relates to eyewear having temples of substantially short length for providing comfort to its wearer.

2. Description of Related Art

Eyewear is used for a number of reasons, such as for vision correction, protection from sun rays, protection from dust particles, protection from light glare, style statement, etc. Further, eyewear may include plastic lenses or lenses made from glass. Furthermore, certain eyewear includes lenses made from glass and protected by a layer of plastic. The frame of the eyewear includes temples to fix the frame of the eyewear on facial structure of a human being. Temples are the side members that extend from lenses or frame of lenses along side of its wearer's head.

Traditionally, the temples are designed with a small downward loop at its end portion and are connected to the frame of the eyewear through hinges. The hinges in the temples of the eyewear enables the temples to be folded, which allows the eyewear to be stored in a convenient fashion. Further, the downward loop at the end of the temples is used to support weight of the eyewear on, and to be received by, the ears of its wearer. This prevents the eyewear from falling off the facial structure of its wearer.

However, the traditional approach of supporting the weight of, and securing, an eyewear on the ears of its wearer presents a number of disadvantages. One such disadvantage is the traditional temples often cause discomfort to its wearer by exerting pressure on an area behind the ears of its wearer. This pressure may be irritating to the wearer and may even cause temporary or even permanent creases/indentations in the wearers head. Such pressure may be reduced by selecting light weight eyewear frames. However, discomfort and irritation behind the ear's area may still exist.

Another disadvantage with traditional temples of eyewear is in the size of the frame of the eyewear. As head sizes of human beings vary from person to person, therefore, there is always a requirement to manufacture frames of the eyewear with a variety of sizes, which introduces a lot of manufacturing cost and resources. Further, it also creates a challenge for a buyer of the eyewear to find and select an eyewear frame that has exact fitting with head and face of the buyer. Also, it does not allow for interchangeability of eyewear between users.

Yet another disadvantage of using traditional temples of eyewear is that the traditional temples complicate wearing of headgears such as caps, hardhats, helmets, knitted headwear, and the like. While wearing a sports cap, for example, it is always difficult to anchor the traditional temples on the ears. Further, the design of the traditional temples is not suitable for athletic events. An additional strap may be a temporarily solution to bind the eyewear behind of the head during athletic events. However, this requires extra cost for purchasing the strap and the strap may be a distraction or violation of the sports' rules.

Therefore, a need exists for an eyewear that solves all the aforementioned disadvantages and provides suitable alternatives for keeping the eyewear in proper position on its wearer's facial structure.

### SUMMARY

Embodiments in accordance with the present invention provide an eyewear system. The eyewear system includes a pair of glasses that may also be lenses. The eyewear system further includes a frame for holding the pair of glasses comprising a nose bridge. The eyewear system further comprises a tensioner attached at the nose bridge for pressurizing/enabling the frame to clutch facial structure of a user who is wearing the eyewear.

Embodiments in accordance with the present invention further provide an apparatus for clutching facial structure of a user. The apparatus includes a pair of temples and glasses. The apparatus further includes a frame comprising a nose bridge and is further connected with the pair of temples via at least two hinges. The apparatus further comprises a tensioner attached at the nose bridge for pressurizing/enabling the frame and the pair of temples to make a grip on facial structure of a user who is wearing the apparatus.

Embodiments in accordance with the present invention further provide an eyewear. The eyewear includes a pair of glasses and temples. The eyewear further includes a frame to support the pair of temples and glasses. The eyewear further includes a spring at nose-bridge of the frame of the eyewear for pressurizing/enabling the frame of the eyewear to attain a folded position.

The present invention can provide a number of advantages depending on the particular configuration. First, the present invention provides an eyewear, an eyewear system, and an apparatus that grips the facial structure of its wearer in a comfortable and reliable manner. Further, the eyewear includes straight temples of short length that reaches only up to about the temple bone of its wearer's head and is not required to be supported by ear of the wearer. Furthermore, the eyewear includes a tensioner at its nose bridge that pressurizes the eyewear to continuously maintain a proper grip on the facial structure of its wearer. Additionally, temples of the proposed eyewear comprise cushions that comfort its wearer from the pressure applied by the tensioner.

Further, the eyewear provided by the present invention enables the people having skin allergies in their ear to wear the eyewear. Furthermore, the eyewear may also be used by the people that do not have an ear or have some irregularities with their ears. Moreover, the proposed eyewear also eases the people who usually wear headgears such as but not limited to, hats, caps, turbans, hardhats, helmets, and the like. In an additional embodiment, the proposed eyewear provides a suitable solution for the athletic players as the proposed eyewear provides a reliable grip on the facial structure of its wearer. Moreover, the proposed eyewear may be used by a number of people as a fashion accessory to enhance their style statements.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 is an exemplary view of a user wearing eyewear, in accordance with an embodiment of the present invention;

FIGS. 2A, 2B, and 2C are various perspective views of eyewear in accordance with an embodiment of the present invention;

FIG. 3 is a top view of the eyewear illustrating the eyewear in a folded/closed position, in accordance with an embodiment of the present invention;

FIGS. 4A and 4B are front views of an eyewear and a tensioner respectively, in accordance with an embodiment of the present invention; and

FIG. 5 illustrates an exemplary flowchart depicting a method for wearing an eyewear comprising a tensioner, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

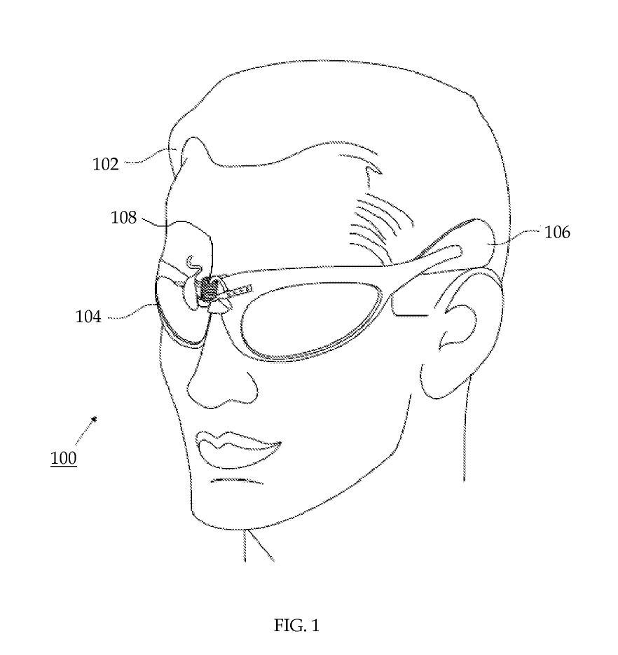

FIG. 1 is an exemplary view 100 of a user wearing eyewear, in accordance with an embodiment of the present invention. The exemplary view 100 includes a user 102 wearing an eyewear frame 104. In an embodiment, the eyewear frame 104 may be used to protect eyes of the user 102 from bright light, or may be used to rectify vision of the user 102. Further, the eyewear frame 104 includes temples 106 of substantially short length (hereinafter, may be referred to as ‘short temples 106’). In an exemplary embodiment of the present invention, the short temples 106 are designed not to reach the ears of the user 102. Therefore, the user 102 needs not to clamp the temples 106 of the eyewear frame 104 onto and around his/her ears for holding the eyewear frame 104 on his/her facial structure.

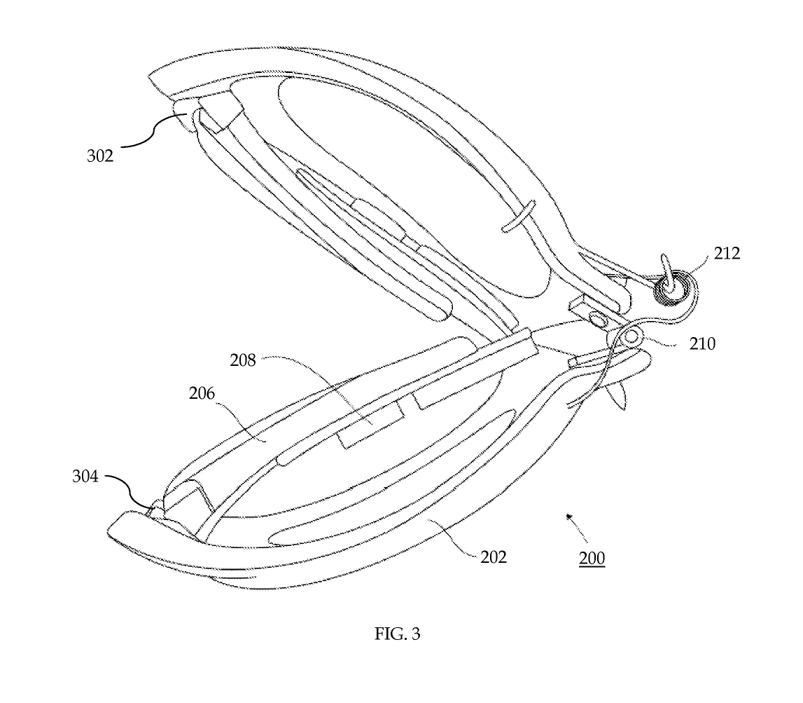

Further, the eyewear frame 104 further comprises a tensioner 108 to hold the eyewear frame 104 on the facial structure of the user 102. The tensioner 108 is designed to press the eyewear frame 104 of the eyewear frame 104 onto the facial structure of the user 102 sufficiently for suppressing falling of the eyewear frame 104 from the facial structure of the user 102. In an embodiment, the tensioner 108 is designed to apply force on the eyewear frame 104 of the eyewear frame 104 to attain a folded position (as shown in FIG. 3). The applied force puts a predetermined, sufficient pressure on the short temples 106 of the eyewear frame 104 (while the short temples are in an open position). The pressure received by the short temples 106 constricts grip of the eyewear frame 104 on the facial structure of the user. This prevents the eyewear frame 104 from falling off the facial structure of the user 102 by providing a comfortable and reliable grip.

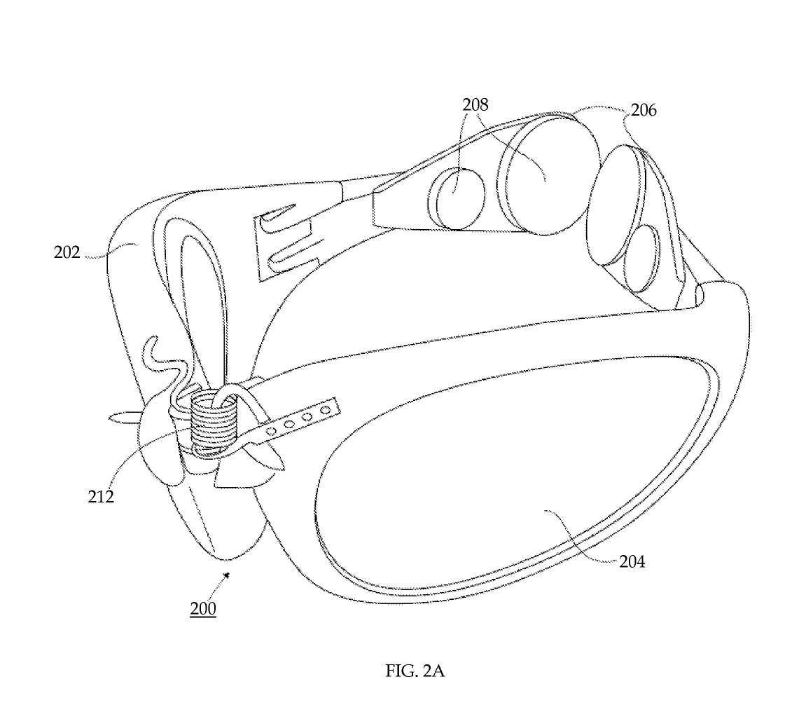

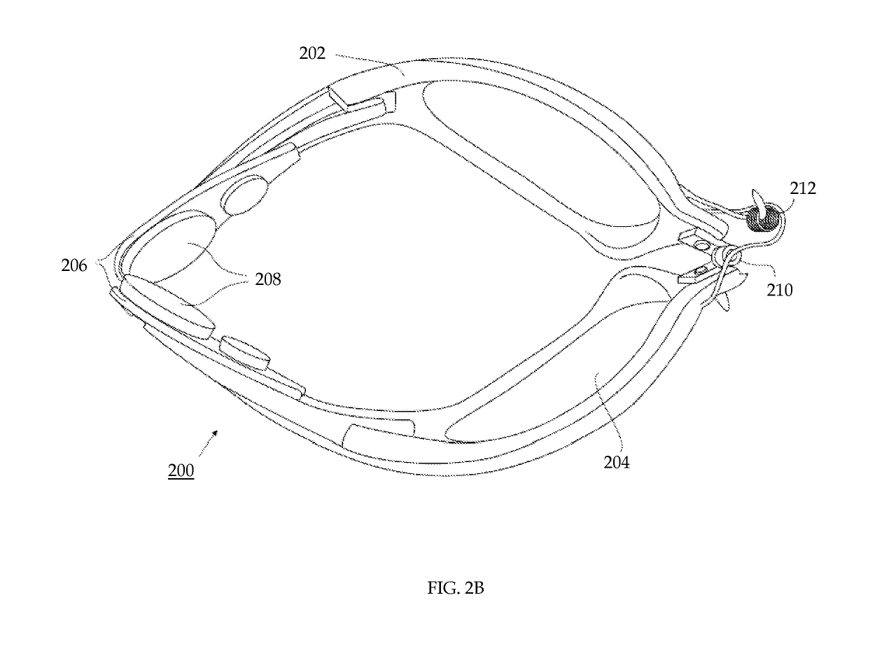

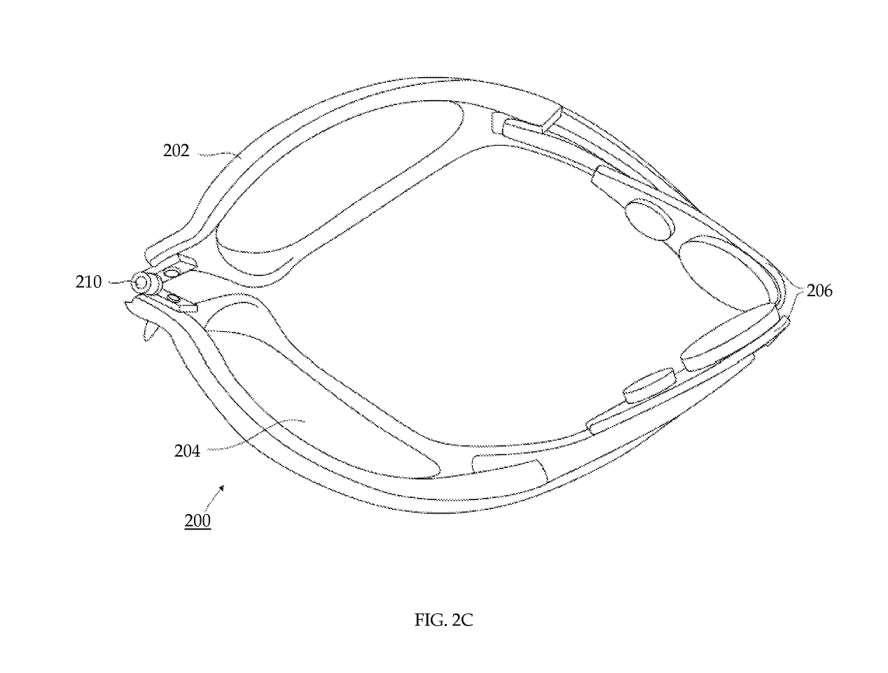

FIGS. 2A, 2B, and 2C are various perspective views of an eyewear 200 illustrating the eyewear 200 in an open position, in accordance with an embodiment of the present invention. The eyewear 200 comprises a frame 202 for holding and supporting glasses 204 in position. The eyewear 200 further comprises two temples 206 that are hinged with the frame 202 of the eyewear 200. In an embodiment of the present invention, the temples 206 are designed as short length temples that are short enough to touch only up to temple bone area of a user (who is wearing the eyewear 200) and are not designed to reach to the ears of the user. An exemplary illustration of the temples 206 can be interpreted from the illustration of temples 106 in the FIG. 1.

Further, the temples 206 are further mounted with cushions 208 to comfort user of the eyewear 200. In addition, the frame 202 of the eyewear 200 includes a hinge 210 as a substitute for or in cooperative combination with a nose-bridge of the eyewear 200. In an embodiment of the present invention, the hinge 210 enables the frame 202 of the eyewear to be folded into a closed position (as shown in FIG. 3) and back to open position (as shown in FIG. 2B).

Further, the hinge 210 on the frame 202 of the eyewear 200 is mounted with a tensioner 212, such as a spring, a tension rod, or a coil. FIGS. 2A and 2B illustrate the tensioner as a spring, in accordance with an embodiment of the present invention. FIG. 2C illustrates the tensioner as a hidden tension rod/wire. Further, the tensioner 212 may be configured to continuously apply force on (or pressurize) the frame 202 of the eyewear 200 for folding the frame into the closed position. The movement of the frame from open position to closed position (or from extended position to folded position) is supported by the hinge 210 of the eyewear 200. Further, the force exerted on the frame 202 by the tensioner 212 ensures a reliable grip of the eyewear 200 on the facial structure of the user. This prevents falling of the eyewear 200 from the facial structure of the user. Further, the cushions 208 ease the pressure of the temples 206 on the facial structure of the user (as the temples 206 cannot be anchored by the ears of the user). This ensures a comfortable experience for the user to wear the eyewear 200.

FIG. 3 is a top view of the eyewear 200 illustrating the eyewear 200 in a folded/closed position, in accordance with an embodiment of the present invention. The eyewear 200 comprises a frame 202 for holding and supporting glasses 204 in position. The eyewear 200 further comprises two temples 206 that are hinged with the frame 202 of the eyewear 200. Hinges 302 and 304 between the frame 202 and the temples 206 enables the temples 206 to be folded into (or traverse between) a closed/folded position (as shown in FIG. 3) and back to the open/extended position (as shown in FIG. 2B). Similarly, the frame 202 of the eyewear 200 includes a hinge 210 as a substitute for nose-bridge of the eyewear 200. The hinge 210 enables the frame 202 of the eyewear to be folded into a closed position (as shown in FIG. 3) and back to open position (as shown in FIG. 2B).

Therefore, the eyewear 200 comprises a total of three hinges, i.e., hinge 210, hinge 302, and hinge 304. These three hinges enable the eyewear 200 to be folded from three different positions. FIG. 3 illustrates the eyewear 200 in folded position from three different positions. In an embodiment, a user may need to open/unfold the temples from the closed/folded position (as shown in FIG. 3) to an open/unfolded position, followed with unfolding of the frame 202 from the folded position to the unfolded position (as shown in FIG. 2C) to attain a overall unfolded position that is suitable for the user to wear the eyewear 200 (as shown in FIG. 1).

Further, the force exerted by the tensioner 212 on the frame 202 of the eyewear 200 may try to force the frame 202 to attain a folded/closed position. Such force, in an overall unfolded position (as shown in FIG. 2C) will be transferred to the temples 206 of the eyewear. Therefore, in a position where a user is wearing the eyewear 200, the force received by the temples will clutch the facial structure (that is in contact with the eyewear 200) of the user to ensure a reliable grip that is sufficient to hold the eyewear 200 on the facial structure of the user and also prevents the eyewear to fall from the facial structure of the user. Furthermore, the cushions 208 on the temples 106 may ensure a proper absorption and distribution of force over the facial structure of the user. This ensures a comfortable experience for the user in wearing the eyewear 200.

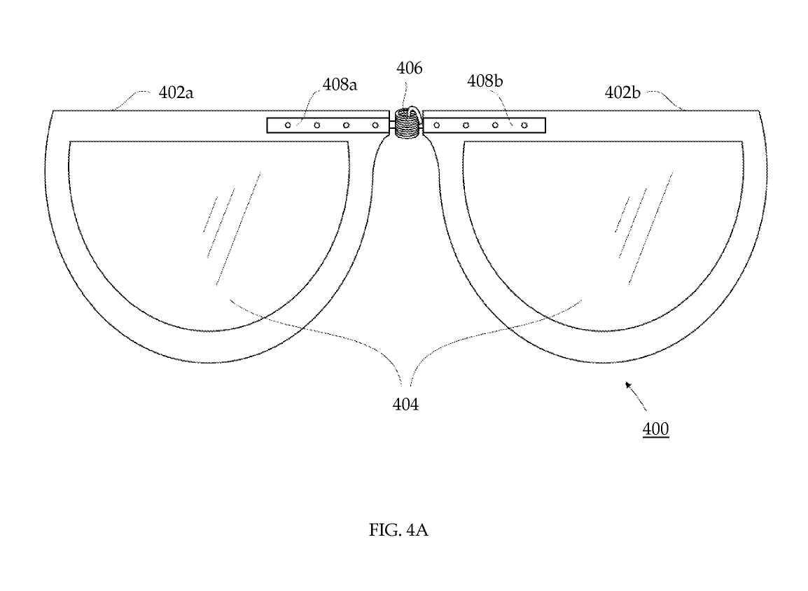

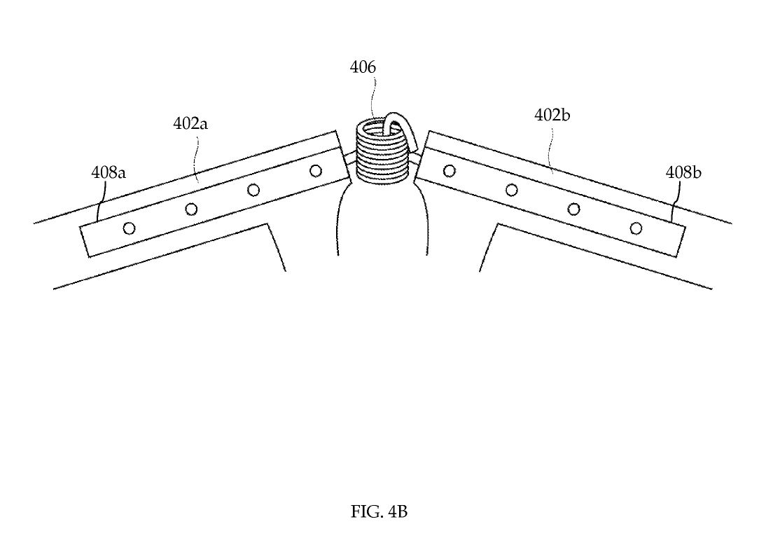

FIG. 4A is a front view of an eyewear 400 illustrating an embodiment of the present invention. The eyewear 400 includes two semi frames 402a and 402b. Each semi frame comprises a lens/glass 404. Further, the semi frames 402a and 402b are connected by a tensioner such as a tension spring 406 with the help of two attachments 408a and 408b. In an embodiment, the two attachments 408a and 408b are designed to attach extended coil (not shown) of the tension spring 406 with the semi frames 402a and 402b.

In an exemplary embodiment of the present invention, the tension spring 406 is designed to push the semi frames 402a and 402b towards each other, as shown in FIG. 4B. FIG. 4B illustrates the tension spring 406 in a folded position, unlike the tension spring illustrated in FIG. 4A, where the tension spring 406 is in extended position. The force exerted by the tension spring 406 on the semi frames 402a and 402b may enable the eyewear 400 to grip the facial structure of the user in a comfortable manner. Further, in an exemplary embodiment, temples (not shown) of the eyewear 400 may be short temples that are designed short enough to not to reach up till ears of a user. Therefore, the tension spring 406 may enable the eyewear 400 to clutch facial structure of the user in a manner convenient to the user. This may prevent falling of the eyewear 400 from facial structure of the user (as the temples of the eyewear are short enough for anchoring on ears of the user).

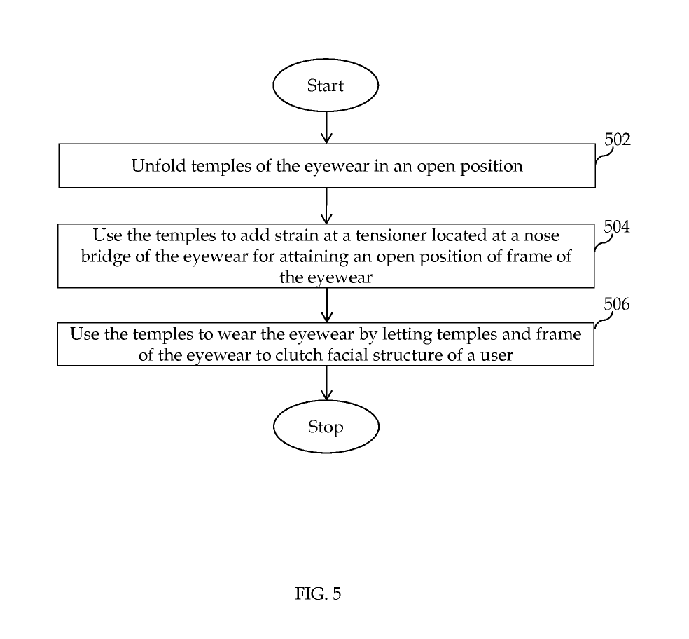

FIG. 5 illustrates an exemplary flowchart depicting a method for securely and conveniently wearing an eyewear comprising a tensioner, in accordance with an embodiment of the present invention. At step 502, a user holds the eyewear with the tensioner in hands to unfold/open temples of the eyewear. In an embodiment, the temples of the eyewear are designed with such a short length that does not allow the temples to touch any part of ear of the user (while the user is wearing the eyewear).

Further, the at step 504, the user pushes the temples apart from each other in order to add tension/stress/strain at the tensioner that is present at nose bridge of the eyewear. The tension/stress/strain may enable (or pressurize) frame of the eyewear to attain an open position from the folded position. This enables a user to wear the eyewear as the temples and frame of the eyewear are now in open/unfolded position. Further, at step 506, as the temples of the eyewear are of short length and cannot be supported by ears of the user, therefore, the user may use the temples of the eyewear to wear the eyewear and let the tension/stress/strain exerted by the tensioner in the nose bridge to clutch facial structure of the user. This enables the eyewear to grip facial structure of the user in a proper manner that prevents falling of the eyewear even during athletic activities.

In an embodiment, the tensioner is designed to force frame of the eyewear to return back to folded position. Such force may be used to provide grip for the eyewear on the facial structure of the user. In an embodiment, the temples of the eyewear are provided with cushion means to comfort the user while wearing the eyewear. Further, the cushions may also be used to suppress the pressure exerted by the temples of the eyewear due to the tensioner.

It may be appreciated by a person skilled in the art that the present invention is not limited to the description provided above with the help of drawings. Further, positions, designs and sizes of various components, as shown in drawings, may not be considered as limiting. Various other embodiments in light of the scope of the present invention may be implemented. Further, the terms like fold, open, close and the like should not be considered as limiting for the present invention.

While the foregoing is directed to embodiments of the present invention, other and further embodiments of the present invention may be devised without departing from the basic scope thereof. In particular, it should be appreciated that any element of any embodiments disclosed herein may be combined with any other elements from any other embodiments disclosed herein, in accordance with yet further embodiments of the present invention.

The present invention, in various embodiments, configurations, and aspects, includes components, methods, processes, systems, kits and apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing apparatus and processes in the absence of items not depicted and/or described herein or in various embodiments, configurations, or aspects hereof, including in the absence of such items as may have been used in previous devices or processes, e.g., for improving performance, achieving ease and reducing cost of implementation.

The foregoing discussion of the present invention has been presented for purposes of illustration and description. The foregoing is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this detailed description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An eyewear system, comprising:
a pair of glasses;
a frame for holding the pair of glasses, the frame comprising a nose bridge; and
a tensioner attached at the nose bridge for enabling the frame to clutch a facial structure of a user.

2. The eyewear system of claim 1 further comprising a pair of temples.

3. The eyewear system of claim 2, wherein each temple is connected with the frame via a hinge.

4. The eyewear system of claim 3, wherein the hinge of each temple is designed to enable each temple to traverse between an extended position and folded position.

5. The eyewear system of claim 2, wherein each temple is configured to clutch temple bone of the user.

6. The eyewear system of claim 2, wherein each temple comprises at least one cushion for reducing clutching pressure on a temple bone of the user.

7. The eyewear system of claim 1, wherein the pair of glasses are lenses.

8. The eyewear system of claim 1, wherein the nose bridge comprising a hinge for allowing movement of the frame due to a pressure exerted by the tensioner.

9. The eyewear system of claim 1, wherein the tensioner is a spring.

10. The eyewear system of claim 1, wherein the tensioner is a coil.

11. The eyewear system of claim 1, wherein the tensioner is a rod.

12. The eyewear system of claim 1, wherein the tensioner is a wire.

13. An eyewear apparatus comprising:
a pair of temples;
a pair of glasses;
a frame coupled with the pair of temples via at least two hinges, the frame comprising a nose bridge; and
a tensioner attached at the nose bridge for fixing the frame and the pair of temples on a facial structure of a user.

14. The eyewear apparatus of claim 13, wherein the pair of glasses are supported by the frame.

15. The eyewear apparatus of claim 13, wherein the at least two hinges of each temple are configured to enable each temple to traverse between an extended position and folded position.

16. The eyewear apparatus of claim 13, wherein each temple from the pair of temples is designed to reach up to a temple bone of the user.

17. The eyewear apparatus of claim 13, wherein the tensioner is configured to let the frame attain a folded position.

18. The eyewear apparatus of claim 13, wherein each temple comprising at least one cushion.

19. The eyewear apparatus of claim 13, wherein the tensioner is a spring.

20. An eyewear comprising:
a pair of glasses;
a pair of temples;
a frame to support the pair of temples and the pair glasses; and
a spring at a nose bridge of the frame of the eyewear for enabling the frame of the eyewear to attain a folded position.

21. A method for securely wearing eyewear having a tensioner, comprising:
unfolding temples of eyewear into an open position;
pushing the temples apart to impart tension into the tensioner; and
placing the eyewear onto the user's head, whereby the temples are securely received by the sides of the user's head.
